(19) United States
(12) Patent Application Publication
(10) Pub. No.: US 2003/0028667 A1
(43) Pub. Date: Feb. 6, 2003

(54) Distribution of information

(76) Inventors: Richard Taylor, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(21) Appl. No.: 10/197,361

(22) Filed: Jul. 17, 2002

(30) Foreign Application Priority Data
Jul. 31, 2001 (GB) 0118670.9

(51) Int. Cl. G06F 15/173

(52) U.S. Cl. 709/238; 709/206

(57) ABSTRACT

Information is distributed within a group or organisation by taking a message in electronic form distributing it to the intended recipient or generating a list of suitable recipients (based on the contents of the database containing details of all individuals and their areas of expertise and/or information related to particularly highly connected individuals) of the message and sends the message to those recipients accordingly. A random distribution model is provided which comprises copying the message a number of times, and generating a list of potential further recipients, and for subsequently selecting a random set of those potential recipients.

### FIELD OF THE INVENTION

This invention relates to a method and apparatus for effective distribution of information and, in particular, to a method and apparatus for effective and efficient knowledge management and for optimising the probability that information and the like reaches at least one suitable recipient therefor.

### BACKGROUND TO THE INVENTION

It is a common problem within relatively large, especially knowledge-based, organisations, particularly those having a number of different sites at several different locations, that information, requests, and other messages entering the organisation at any one site or receiving office, do not always reach the person or department best suited to answer a question, use incoming information or solve a problem. This is largely due to the fact that most people, groups or departments within the organisation are likely to be familiar with the work and/or expertise of very few of the other people, groups or departments, either within their own site or elsewhere within the organisation. Thus, the initial recipient of a piece of correspondence requiring action are unlikely to have the best or sufficient knowledge of the activities of other areas of the organisation to redirect the correspondence accordingly or at least collaborate with the correct person, group or department to action the correspondence in the most efficient and effective manner possible.

Of course, one way to solve this problem would be to copy and send the correspondence to everyone within the organisation, which is obviously inefficient and places an enormous and often unnecessary burden on the organisation's communication resources, as well as placing an unacceptably large burden on all individuals within the organisation by continuously bombarding them with information and requests for information which they cannot satisfy, leading to such messages being discarded or deleted without thought.

Another method of solving the problem outlined above is to set up and maintain a database or similar bank of information which holds details of all people, groups and departments within an organisation and their areas of expertise/interest so that correspondence can be addressed and directed straight to a suitable recipient by consulting the information held in the database, or by electronically flagging key words or phrases and routing queries according to matches between problems and potential solution providers. One of the main problems with this is that such a database is rarely maintained to the extent that it can be relied upon to give accurate, complete and up-to-date information as required. As a result, people tend not to consult the database because it is considered to be out of date or inaccurate. Another problem, associated with the keyword/phrase flagging and matching process is the frequent inability to generalise based upon such key words and phrases.

Yet another solution would be to provide a human version of the database solution described above, this consisting of one or more individuals who know which individuals and groups within the organisation are doing what, and giving such individuals the task of matching problems to suitable solution providers. However, although this solution permits a certain amount of exploration by the highly knowledgeable individuals of connections which would go beyond most electronic implementations based upon the above-described database solution, this method still tends to fail because the range of specialities and extent of knowledge of individuals is limited (and this solution is in any event often expensive), and tends only to work when the problems to be solved are relatively large and the cost of maintaining the knowledge of selected individuals can be justified.

### SUMMARY OF THE INVENTION

In accordance with the present invention, there is provided a method of distributing messages within a group or organisation comprising a number N of potential recipients for said messages, the method comprising the steps of receiving a message and directing said message to a number M of predetermined recipients or recipients selected according to a predetermined criterion, producing one or more further copies of said message and distributing said one or more copies to one or more respective further recipients randomly selected from the remaining number N-M of potential recipients (or a predetermined set thereof) within said group or organisation.

Also in accordance with the present invention, there is provided apparatus for distributing messages within a group or organisation comprising a number N of potential recipients for said messages, the apparatus comprising means for receiving a message, means for directing said message to a number M of predetermined recipients or recipients selected according to a predetermined criterion, means for producing one or more further copies of said piece of correspondence/information and means for distributing said one or more copies to one or more respective further recipients randomly selected from the remaining number N-M of potential recipients (or a predetermined set thereof) within said group or organisation.

“Messages” is here used in its most general sense of information that is communicated from a sender to a recipient. The nature of these messages may vary depending on the embodiment of the invention. In a conventional e-mail system, these messages may be normal e-mails, but in a system designed specifically for information exchange, the messages maybe simply pieces of information rather than structured as correspondence.

The predetermined set from which the further recipients may be selected may comprise a set of groups created through known structures, such as departments.

The correspondence is beneficially distributed in electronic form, by means of, for example, e-mail or the Internet. The M initial recipients maybe predetermined by the sender of a piece of correspondence or information. Alternatively or in addition, the M recipients may be selected from one or more highly connected individuals or groups within the organisation, and/or from information held in a database or similar storage means regarding individuals and groups within the organisation and their respective areas of expertise. The identity and number of additional randomly selected recipients may be chosen according to various criteria, including the number of N-M remaining potential recipients, the time limit within which a response is required, etc.

N and M are integers, with M being 1 or more. The number of randomly selected further recipients for a piece of correspondence or information preferably lies in the range of 0.001% to 50% of N-M. In a more preferred embodiment, this range is in the range 0.001 to 30% of N-M, and even more preferably in the range 0.001 to 20% of N-M.

In a further aspect, the invention provides computing apparatus programmed for distributing messages within a group or organisation comprising a number N of potential recipients for said messages, the apparatus comprising means for receiving a message directed to a number M of predetermined recipients or recipients selected according to a predetermined criteria, the computing apparatus being programmed to produce one or more further copies of said piece of correspondence/information and to distribute said one or more copies to one or more respective further recipients randomly selected from a predetermined selection of the remaining number N-M of potential recipients within said group or organisation.

In a further aspect, the invention provides a data carrier carrying code adapted to program a computer for distributing messages within a group or organisation comprising a number N of potential recipients for said messages, the code being adapted to program the computer to receive a message directed to a number M of predetermined recipients or recipients selected according to a predetermined criteria, to produce one or more further copies of said piece of correspondence/information and to distribute said one or more copies to one or more respective further recipients randomly selected from a predetermined selection of the remaining number N-M of potential recipients within said group or organisation.

The present invention essentially employs a known random graph theory, which will be described in more detail hereinafter, to the distribution of information, data, etc. within real groups and organisations comprising relatively large numbers of people or bodies, thereby substantially increasing the probability that the information, data, etc. will be received by the best person or body to use/deal with that data or information, or at least by a person or body who is familiar with such a person or body, without placing a significant load on the whole organisation and increasing the likelihood that any one individual would be prepared to respond appropriately (by reading a request and responding to it directly, deleting it or forwarding it) because this solution involves only very infrequent demands on their time.

In other words, the present invention employs a deliberate randomisation process to aid the dispersement of information of information to appropriate parts of a group or organisation made up of a relatively large number of people or parties.

In one preferred embodiment of the invention, provision is provided whereby the random distribution process is not applied, or only applied in a limited capacity, to certain types of correspondence/information, particularly of a private, confidential or sensitive nature.

### BRIEF DESCRIPTION OF THE DRAWINGS

An embodiment of the present invention will now be described by way of example only and with reference to the accompanying drawings, in which:

FIG. 1A is a graph representing a regular network;

FIG. 1B is a graph representing a semi-regular network;

FIG. 1C is a graph representing a random network; and

FIG. 2 is a block diagram representing functional elements of an exemplary embodiment of the present invention; and

FIG. 3 is a flow diagram showing steps in an exemplary embodiment of a method of the present invention.

### DETAILED DESCRIPTION OF THE INVENTION

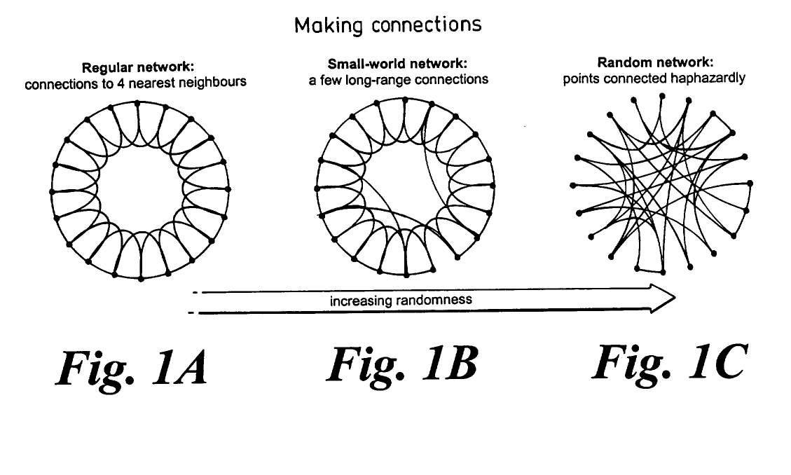

Referring to FIGS. 1A-1C of the drawings, the random graph theory which provides the basis for the present invention. Until recently, most networks have been categorised into two broad types. Referring to FIG. 1A of the drawings, the first type is a so-called regular network which has every point or node 10 connected in the same way (via edges 12) to the same number of neighbouring nodes 10: for example, as shown in FIG. 1A, just four connections to the four nearest neighbours. It can be seen that such networks are highly clustered in that nearby nodes are connected by a high density of links. At the other extreme, referring to FIG. 1C of the drawings, a random network has points connected haphazardly some to their nearest neighbours, but many more to distant parts of the network. As a result, the network has a relatively small “step-length”, a measure of the typical number of steps between any two points. However, such graphs also have little clustering of nearby points.

However, neither of the two types of graph described above tends to accurately define a real organisation, such as a large business organisation including many people and groups therein, spread over a number of sites in different locations. Referring to FIG. 1B of the drawings, a typical such organisation can more accurately defined by a regular graph having a few distant connections, which has been found to drastically cut the step-length and yet still retain the high levels of clustering found in a real organisation, in which most people or parties are familiar with only a few of the other people or parties in the organisation, but in which there are a few “highly connected” people or parties who are familiar with a substantial number of other people or parties within the organisation. As such, this type of random graph or network illustrates the true “small world” effect typical of large organisations, with apparently unrelated clusters being connected to others via a few steps.

The present invention exploits the fact that it is unnecessary to directly ‘hit’ a suitable potential recipient of information/data because of the connections between apparently unrelated clusters (or groups) created by a few “highly connected” people. The probability of a single copy of a message hitting the ideal recipient is relatively low, but is substantially increased by sending a number of copies of the same message to a respective number of randomly selected other potential recipients, without the need to unnecessarily burden the organisation's communication network. The net effect is to destructure the organisation.

An exemplary embodiment of the invention will now be described. The invention is particularly suitable for use in a conventional e-mail architecture with an e-mail server and a number of e-mail clients. It should be noted, however, that it is not necessary for such an architecture to be employed to make effective use of the invention. Essentially any conventional message communication system can be adapted for the present purpose, whether intranet-based, peer-to-peer or otherwise. It is also unnecessary for the communicated messages to be in the form of correspondence—they may be simply pieces of information (as may be appropriate in a communication system dedicated to this purpose, rather than in, say, a conventional e-mail system which is adapted to provide information exchange of this type as an additional feature).

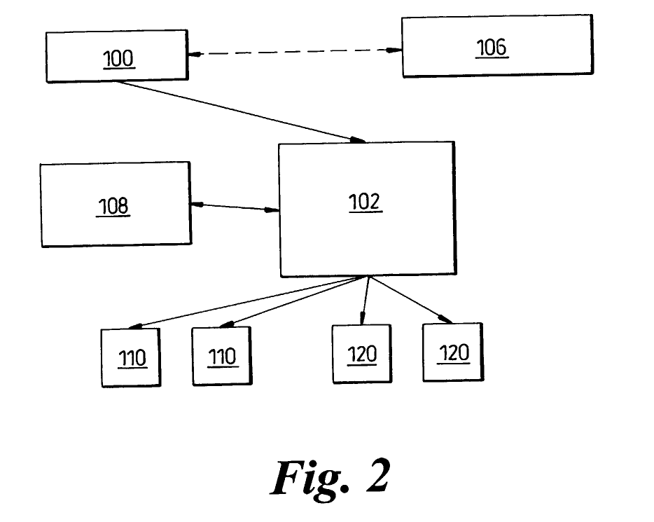

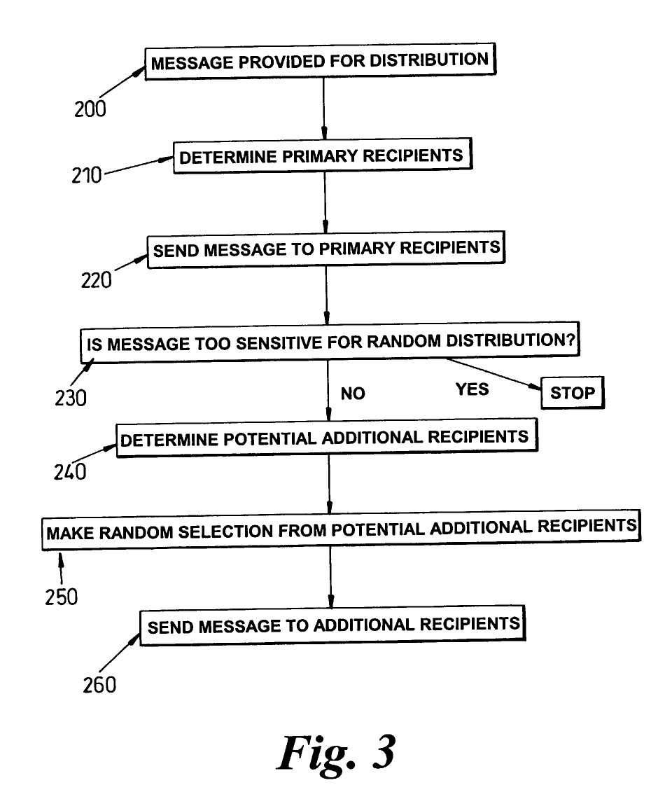

Referring now to FIGS. 2 and 3 of the drawings, an exemplary embodiment of the invention is described. A message in electronic form for distribution is provided at step 200. This may be either generated at a mail client 100, or it may be a message received at a mail server 102 meeting appropriate parameters for distribution according to embodiments of the invention (in which case the mail server 102 must be adapted to scan incoming messages). In step 210, the primary recipients for the message are determined. This can be simply a matter of selection of recipients by the message composer in a conventional manner, but may also involve selection of a list of suitable recipients from a database 106 of individuals and their areas of expertise and/or information related to particularly highly connected individuals, as described above. This database may be separate from the mail client 100 and mail server 102, but may alternatively be combined with one of them. In step 220, the message is sent to the mail clients of the primary recipients 110 through the mail server 102.

In step 230, the sensitivity of the message is evaluated (this can be done either at the mail client 100 or mail server 102, depending on the preferred architecture for the mail system). If the sensitivity of the message is high, then it is not appropriate to send it to a random selection of further recipients, and no further steps are taken. If the sensitivity is low, then random distribution is appropriate and the random distribution steps as described below follow. If the sensitivity is intermediate, then a further possible approach is described below.

In step 240, the message is provided to the random distribution module 108 (which can be located at the mail client 100, more advantageously at the mail server 102, but potentially anywhere with access to the mail system) which generates a list of potential further recipients. These further recipients may at the broadest be every user of the e-mail system other than the intended recipients, but may also be those indicated as having expertise in a particular subject area, may be located in a particular geography, or may be those who have opted in to (or not opted out of) the random distribution system. For intermediate sensitivity messages, there may also be a list of appropriate recipients for intermediate sensitivity messages, or this can be derived from the organisation or status of the sender and primary recipients of the message. Once the list of potential recipients has been established, in step 250 a random set of those potential recipients is selected to provide the additional recipients (multiple functions based upon the size of the initial set of potential recipients and the speed of response required, for example, can be used to select/generate this set).

In step 260, the random distribution module then distributes the respective copies of the message to the generated set of further recipients 120 with a request to respond directly to the message, forward it to a more suitable recipient, or delete the message without action. The message need not hit the ideal recipient directly using this process, because the probability of it hitting, or at least coming very close to, a “highly connected” party is very high so that the probability of the message getting to the ideal recipient is also high.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. A method of distributing messages within a group or organisation comprising a number N of potential recipients for said messages, the method comprising the steps of sending a message to a number M of predetermined recipients or recipients selected according to predetermined criteria, producing one or more further copies of said message and distributing said one or more copies to one or more respective further recipients randomly selected from a predetermined selection from the remaining number N-M of potential recipients within said group or organisation.

2. A method according to claim 1, wherein said predetermined selection comprises all the remaining number N-M of potential recipients.

3. A method according to claim 1, wherein said messages are distributed in electronic form.

4. A method according to claim 1, wherein said M initial recipients are predetermined by the sender of a piece of correspondence or information.

5. A method according to claim 1, wherein said M recipients are selected from information held in a database regarding individuals or groups within the organisation and their respective areas of expertise or their connectedness within the organisation.

6. A method according to claim 1, wherein the identity and number of additional randomly selected recipients is chosen according to criteria, including one or more of the number of N-M remaining potential recipients, and the time limit within which a response is required.

7. A method according to claim 1, wherein the number of randomly selected further recipients for a piece of correspondence or information lies in the range of 0.001% to 50% of N-M, more preferably in the range 0.001 to 30% of N-M, and even more preferably in the range 0.001 to 20% of N-M.

8. Computing apparatus programmed for distributing messages within a group or organisation comprising a number N of potential recipients for said messages, the apparatus comprising means for receiving a message directed to a number M of predetermined recipients or recipients selected according to a predetermined criteria, the computing apparatus being programmed to produce one or more further copies of said piece of correspondence/information and to distribute said one or more copies to one or more respective further recipients randomly selected from a predetermined selection of the remaining number N-M of potential recipients within said group or organisation.

9. Computing apparatus as claimed in claim 8, wherein said predetermined selection comprises all the remaining number N-M of potential recipients.

10. Computing apparatus according to claim 8, wherein said correspondence/information is distributed in electronic form.

11. Computing apparatus according to claim 8, wherein the identity and number of additional randomly selected recipients is chosen according to criteria, including one or more of the number of N-M remaining potential recipients, and the time limit within which a response is required.

12. Computing apparatus according to claim 8, wherein the number of randomly selected further recipients for a piece of correspondence or information lies in the range of 0.001% to 50% of N-M, more preferably in the range 0.001 to 30% of N-M, and even more preferably in the range 0.001 to 20% of N-M.

13. A data carrier carrying code adapted to program a computer for distributing messages within a group or organisation comprising a number N of potential recipients for said messages, the code being adapted to program the computer to receive a message directed to a number M of predetermined recipients or recipients selected according to a predetermined criteria, to produce one or more further copies of said piece of correspondence/information and to distribute said one or more copies to one or more respective further recipients randomly selected from a predetermined selection of the remaining number N-M of potential recipients within said group or organisation.

14. A data carrier as claimed in claim 13, wherein said predetermined selection comprises all the remaining number N-M of potential recipients.

15. A data carrier as claimed in claim 13, wherein the identity and number of additional randomly selected recipients is chosen according to criteria, including one or more of the number of N-M remaining potential recipients, and the time limit within which a response is required.

16. A data carrier as claimed in claim 13, wherein the number of randomly selected further recipients for a piece of correspondence or information lies in the range of 0.001% to 50% of N-M, more preferably in the range 0.001 to 30% of N-M, and even more preferably in the range 0.001 to 20% of N-M.
